(19) United States
(12) Patent Application Publication
(10) Pub. No.: US 2022/0178388 A1
(43) Pub. Date: Jun. 9, 2022

(54) HIGH-CAPACITY BLADDER TYPE CONSTANT PRESSURE ACCUMULATOR AND APPLICATION THEREOF

(71) Applicant: SHANDONG UNIVERSITY OF SCIENCE AND TECHNOLOGY, Qingdao (CN)

(72) Inventors: Lirong WAN, Qingdao (CN); Zhengmiao YU, Qingdao (CN); Qingliang ZENG, Qingdao (CN); Wenting LIU, Qingdao (CN); Hanzheng DAI, Qingdao (CN); Zhiyuan SUN, Qingdao (CN); Mingqian TIAN, Qingdao (CN)

(21) Appl. No.: 17/273,399

(22) PCT Filed: Dec. 23, 2019
(86) PCT No.: PCT/CN2019/127732

§ 371 Date: Mar. 4, 2021

(30) Foreign Application Priority Data
Aug. 29, 2019 (CN) 201910805386.6

(51) Int. Cl. F15B 1/24

(52) U.S. Cl. CPC F15B 1/24; F15B 2201/4155; F15B 2201/312

(57) ABSTRACT

A large-capacity bag-type constant-pressure accumulator comprises a shell and a bag placed in the shell, as well as a variable area piston, a floating piston, a piston, and a flange. On the piston rod of the variable area piston is mounted the floating piston, while at the bottom of the variable area piston rod is connected the piston. Additionally, through holes are provided on the central axes of the variable area piston and the piston; such holes are connected to the bag through an inflation valve and connected with a cover plate at the bottom. On the piston are arranged the check valves I and check valves II. The flange is connected to the inner wall of the shell bottom.

### TECHNICAL FIELD

The invention is related to a large-capacity bag-type constant-pressure accumulator and its application, particularly to a large-capacity bag-type constant-pressure accumulator that is applicable to the hydraulic system for all kinds of machinery, and belongs to the technical field of accumulator.

### BACKGROUND ART

As the hydraulic system of construction machinery evolves, problems such as shock and pressure pulsation are becoming increasingly severe. Meanwhile, the hydraulic system is also required to realize energy recovery for the sake of environmental protection and energy saving. To adapt to the hydraulic system development, various types of accumulators are being used more and more widely and have become pretty important energy storage elements in the hydraulic system, playing an important role in pressure pulsation absorbing and energy recovery.

Currently, for most of the existing accumulators, except gravity loaded accumulators, their pressure drops continuously while they are releasing hydraulic energy outward, which will further produce pressure and flow pulsation in the pipelines. After the internal pressure of the accumulators drops to the system pressure, the accumulators will become unable to discharge oil outward again, so their effective volume is not high, that is, the “dead volume” problem exists.

Hydraulic accumulators, as very common devices in the hydraulic system, can store pressure energy, eliminate pressure pulsation, reduce noise, absorb hydraulic shock, compensate leakage, or act as auxiliary (or emergency) power sources. However, most of the existing hydraulic accumulators cannot output constant-pressure oil. A constant-pressure oil output can reduce the hydraulic shock caused by the hydraulic accumulator on the hydraulic pipelines and various accessories while releasing energy, thus reducing the shock vibration and noise in the loops, prolonging the life of related components, and simplifying the hydraulic pipelines to a certain extent.

To solve the problem that the output pressure of the accumulator drops continuously, Professor Eric Bass of Vanderbilt University proposed a new concept of constant-pressure accumulator. Professor Zhang Guoxian of Shanghai University has studied the structure as well and found that it has changed the problem of constantly decreasing pressure in the oil discharge process of the traditional accumulators and has improved the volume energy density.

However, there are still problems with the existing constant-pressure accumulator (system) solutions as follows: (1) diaphragm-type constant-pressure accumulators can only slightly alleviate the dead volume problem; (2) diaphragm-type constant-pressure accumulators adopt small-volume diaphragm structure and thus cannot be applied to high-flow construction machinery; (3) gravity-loaded accumulators have large volume and slow reaction speed and are seldom used currently; and (4) constant-pressure accumulator systems have many components and complex structures.

### DESCRIPTION OF THE INVENTION

In view of the shortcomings of the existing technologies, the invention discloses a large-capacity bag-type constant-pressure accumulator which uses a large-capacity bag to realize energy storage and constant-pressure buffer in the working process of the hydraulic system, and can adapt to the large-capacity requirements of the construction machinery.

The invention also discloses an operating method of the said large-capacity bag-type constant-pressure accumulator.

The technical solution of the invention is as follows:

A large-capacity bag-type constant-pressure accumulator, which comprises a shell and a bag placed in the shell, as well as a variable area piston, a floating piston, a piston, and a flange. On the piston rod of the variable area piston is mounted the floating piston, while at the bottom of the variable area piston rod is connected the piston. Additionally, through holes are provided on the central axes of the variable area piston and the piston. Such holes are connected to the bag through an inflation valve and connected with a cover plate at the bottom. On the piston are arranged the check valves I and check valves II. The flange is connected to the inner wall of the shell bottom.

According to a preferred embodiment of the invention, the variable area piston is of an arc shaped construction. As the arc shaped construction is more easily to fit with the bag in the process of squeezing the bag, such a design can prevent the sharp edges and corners from piercing through the bag.

According to a preferred embodiment of the invention, the piston rod of the said variable area piston is connected to the piston with threads with its bottom.

According to a preferred embodiment of the invention, on the surface of the piston are provided multiple grooves in which O-rings are placed. As the O-rings have good sealing effects, such a design can prevent the piston from oil leakage.

According to a preferred embodiment of the invention, the said inflation valve is connected to the through roles with threads.

According to a preferred embodiment of the invention, the said cover plate is provided with a threaded stud which is inserted into the bottom of the through holes and connected to the holes with threads.

According to a preferred embodiment of the invention, a sponge gasket is provided between the cover plate and the piston.

According to a preferred embodiment of the invention, the cover plate is provided with a small hole. During the removal of the variable area piston, a hook may be used to hook the small hole to pull the variable area piston out easily.

According to a preferred embodiment of the invention, the said flange is connected to the inner wall of the shell through threads and fixed by set screws.

According to a preferred embodiment of the invention, the said piston is provided with two check valves I and two check valves II. They are arranged and evenly distributed on the same circle at certain spacing, but their opening direction is opposite to each other.

An operating method of the large-capacity bag-type constant-pressure accumulator, which comprises steps as follows:

When the accumulator stores energy, high pressure will build up on the hydraulic oil side and drives the variable area piston to move. The variable area piston then squeezes the bag and the pressure inside the bag increases as the gas is compressed. During this process, the effective force-bearing area of the variable area piston will decrease gradually. Then, check valves I open and check valves II close; and the oil flows through the check valves I into the chamber of the floating piston, which can reduce the speed of the bag being compressed while increase the accumulator capacity, thus reducing heat production;

When the accumulator releases energy, the variable area piston will deliver pressure to push the hydraulic oil to discharge. With the expanding of the gas inside the bag, the pressure of the gas will gradually decrease, while the effective force-bearing area of the variable area piston will enlarge. Then, the check valves I close, and the check valves II do not open until the oil pressure inside the chamber of the floating piston becomes larger than the set oil pressure in the chamber of the piston. After the check valves II open, the oil will be discharged into the chamber of the piston via the valves, which can reduce the pressure pulsation when the accumulator releases energy and maintain a constant pressure.

The beneficial effects of the invention are as follows:

1) The invention adopts a bag-type structure which has a capacity larger than that of the diaphragm-type constant-pressure accumulator and can adapt to small-, medium- and large-sized hydraulic systems by selecting parameters, such as bag specification and inflation pressure, according to the size of the hydraulic system. Compared to the gravity loaded accumulator, the bag-type accumulator is more sensitive in reaction. Its bottom (namely the part that is connected to the inflation valve) is of a planar structure to ensure that the deformation of the bag conforms to the design requirements.

2) The cup-shaped variable area piston in the invention is made of hard aluminum alloy, which can reduce the weight as much as possible under the premise of meeting the strength requirements, thus giving the accumulator a higher sensitivity. This cup-shaped variable area piston can maintain a basically constant output hydraulic oil pressure, reduce the pressure pulsation when the accumulator discharges the oil, and minimize the system pressure fluctuation as the effective area of the piston will increase with the bag expands and the gas pressure inside it decreases. The upper part of it in contact with the bag is of an arc-shaped structure with chamfered edges and corners to reduce stress concentration, make deformation of the bag relaxed, and reduce the requirements on the materials of the bag. The variable area piston can be designed appropriately for specific system to minimize or even eliminate the “dead volume”.

3) The piston of the invention is arranged with two sets of check valve type oil holes, with two in each set. They can not only make full use of the internal space of the accumulator to increase the oil storage quantity of the accumulator, but also perform a “buffer” function to balance the oil pressure of the chambers of the variable area piston and the floating piston, thus slowing down the pressure change inside the accumulator in the process of energy storage and release, extending the service life of the bag to a certain extent, and making the oil pressure more stable in the process of energy release. As the bag is not in direct contact with the hydraulic oil, the service life of the bag can be extended to some extent. Even if the bag breaks up, the floating piston can also act as a seal to separate the air chamber and the liquid chamber, guaranteeing that there will be no gas entering the oil and thus avoiding shock vibration, gas cavitation and other problems.

4) The inflation valve of the bag in the invention is connected to the variable area piston with threads; the shell adopts integral structure to facilitate sealing; and the end flange can facilitate disassembly, maintenance, and inflation.

### BRIEF DESCRIPTION OF THE FIGSURES

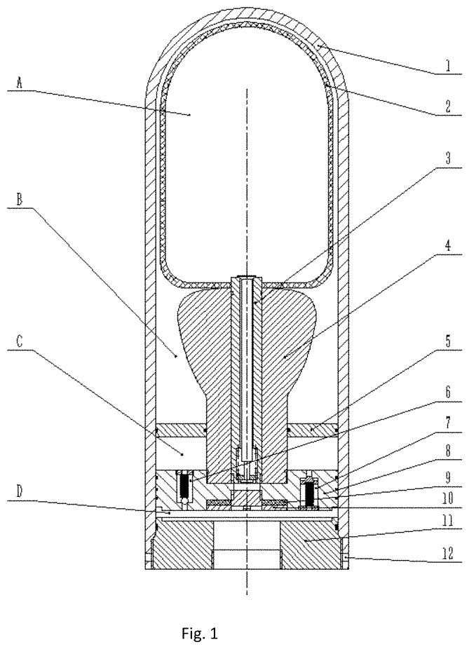

FIG. 1 shows the structure diagram of the accumulator in the invention;

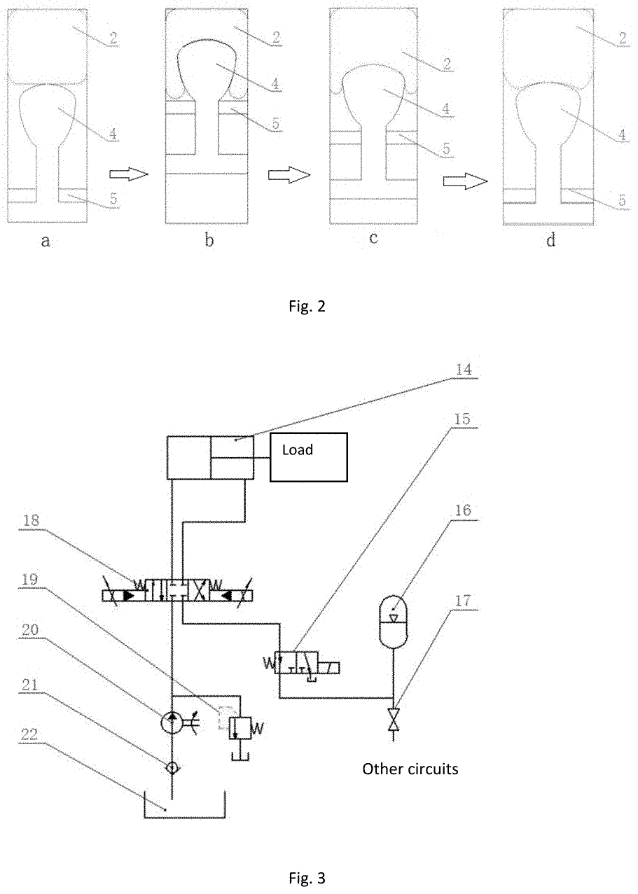

FIG. 2 shows the schematic diagram of the energy storage and release process of the accumulator in the invention;

FIG. 3 shows the schematic diagram of the energy recovery system for the hydraulic excavator boom;

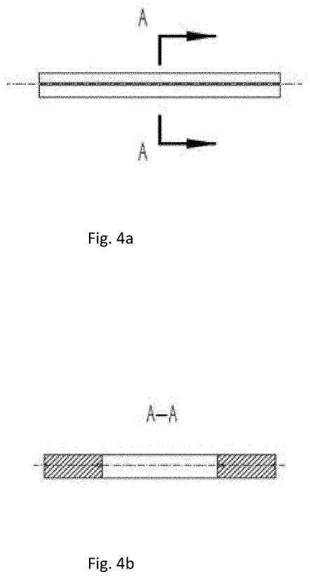

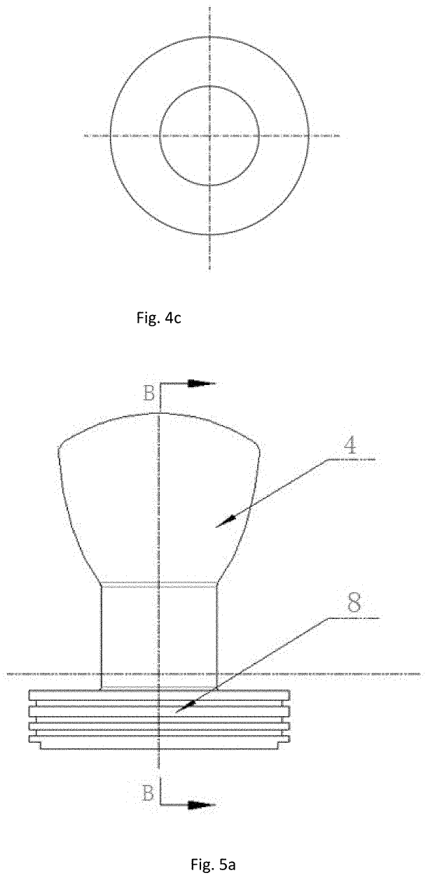

FIG. 4a shows the front view of the floating piston;

FIG. 4b shows the cross-section diagram of the floating piston in A-A direction;

FIG. 4c shows the top view of the floating piston;

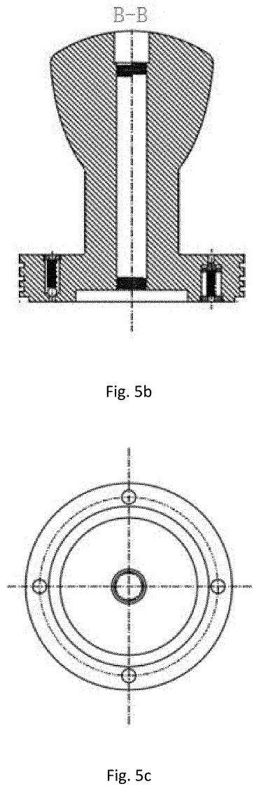

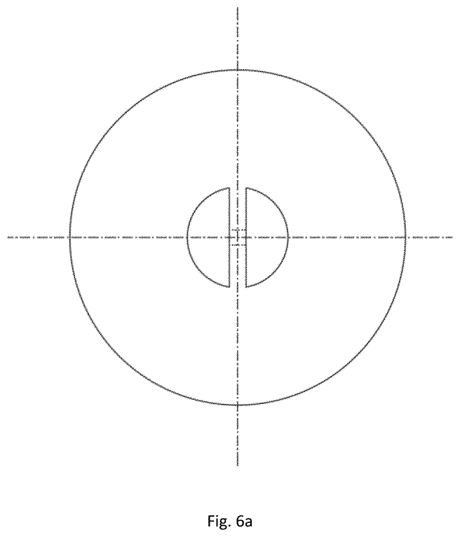

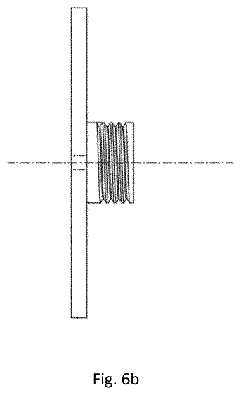

FIG. 5a shows the front view of the variable area piston;

FIG. 5b shows the cross-section diagram of the variable area piston in B-B direction;

FIG. 5c shows the top view of the variable area piston;

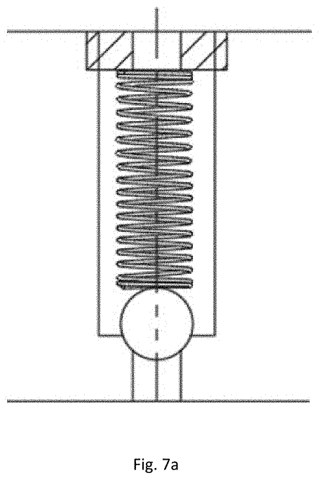

FIG. 6a shows the front view of the cover plate;

FIG. 6b shows the left view of the cover plate;

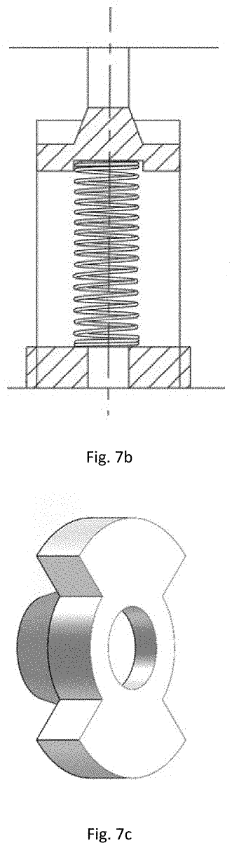

FIG. 7a shows the structure diagram of the check valve I;

FIG. 7b shows the structure diagram of the check valve II;

FIG. 7C shows the three-dimensional diagram of the valve element in the check valve II;

Where: 1—Shell, 2—Bag, 3—Inflation valve, 4—Variable area piston, 5—Floating piston, 6—Check valve I, 7—Check valve II, 8—Piston, 9—Gasket, 10—Cover plate, 11—Flange, 12—Set screw, 14—Boom cylinder, 15—Reversing valve, 16—Accumulator overflow valve, 17—Stop valve, 18—Three-position four-way solenoid directional control valve, 19—Overflow valve, 20—Hydraulic pump, 21—Check valve, 22—Oil tank, A—Air chamber, B—Variable area piston chamber, C—Floating piston chamber, D—Piston chamber.

### DETAILED EMBODIMENTS

The invention is further described in combination with the attached figures and embodiments as follows, but is not limited to that.

### Embodiment 1

As shown in FIG. 1, the embodiment provides a large-capacity bag-type constant-pressure accumulator, which comprises a shell 1 and a bag 2 placed in the shell 1, as well as a variable area piston 4, a floating piston 5, a piston 8, and a flange 11. On the piston rod of the variable area piston 4 is mounted the floating piston 5, while at the bottom of the variable area piston rod is connected the piston 8. Additionally, through holes are provided on the central axes of the variable area piston 4 and the piston 8. Such holes are connected to the bag 2 through an inflation valve 3 which connects to the through holes with threads, and are connected with a cover plate 10 at the bottom. On the piston 8 are arranged the check valves I 6 and check valves II 7. The flange 11 is connected to the bottom inner wall of the shell 1.

To be specific, the variable area piston 4 is of an arc shaped construction, and looks like a cup as a whole, with its bottom connected with a piston rod. As the arc shaped construction is more easily to fit with the bag 2 in the process of squeezing the bag, such a design can not only prevent the sharp edges and corners from piercing through the bag, but also reduce stress concentration, make deformation of the bag relaxed, and reduce the requirements on the materials of the bag.

The piston rod of the variable area piston 4 is connected to the piston 8 with threads with its bottom. The floating piston 5 is mounted on the piston rod of the variable area piston 4. The floating piston 5, the piston rod, and the shell 1 are highly airtight, which can effectively isolate gas and oil and prevent them from flowing to each other. On the surface of the piston 8 are provided multiple grooves in which O-rings are placed. As the O-rings have good sealing effects, such a design can prevent the piston from oil leakage.

There are two segments of threads inside the through hole, with the upper threads used to connect the bag 2 and the lower threads used to connect the cover plate 10. On the cover plate 10 is provided with a threaded stud which is inserted into the bottom of the through hole and connected to the hole with threads. A sponge gasket 9 is provided between the cover plate 10 and the piston 8, acting as a seal. In the center of the cover plate 10, there is a small hole which is used to facilitate the removal of the variable area piston.

The inflation valve 3 is provided inside the through hole and used to inflate the bag 2. In case of gas leakage from the bag, the hydraulic joint connected with the flange 11 will need to be removed for inflation or replacement of the bag 2. When inflation is needed, remove the hydraulic joint, unscrew the cover plate 10, and take down the sponge gasket 9; then complete the inflation with an inflation device cooperating with the inflation valve 3.

The flange 11 is connected to the inner wall of the shell 1 through treads and fixed by the set screws 12 on the shell. When the accumulator is used to specific working environment subsequently, the flange 11 will be used to connect the hydraulic joint.

The piston 8 is provided with two check valves I 6 and two check valves II 7. They are arranged and evenly distributed on the same circle at certain spacing, but their opening direction is opposite to each other. The check valves I 6 are distinguished from the check valves II 7 in structure. As shown in FIG. 7a, the check valve I 6 uses a spring inside the valve body to hold up a steel ball for sealing of the valve port, and needs a relatively small pressure to open; so, in the process of energy storage, it is easy for the high pressure oil to jack up the steel ball and enter the floating piston chamber. While, as shown in FIG. 7b and FIG. 7c, the check valve II 7 uses a spring inside the valve body to hold up the valve element for sealing of the valve port and needs a large pressure to open (its structure can be designed specially to offer a certain opening pressure); so, in the energy release process, the oil inside the floating piston chamber can only open the check valve II 7 after reaching a certain pressure value, and then flows out of the chamber. By designing different opening pressure for the check valve I 6 and the check valve II 7, the oil can flow easily into the floating piston chamber in the energy storage process, but can only be discharged after the pressure of the floating piston chamber becomes higher than that of the piston chamber by a certain value in the energy release process, thus maintaining a constant-pressure output to some extent.

The new large-capacity bag-type constant-pressure accumulator disclosed in the invention has a variety of advantages, such as seldom leakage, long service life, small inertia, sensitive reaction and wide range of applicable volume, and can be widely used in various hydraulic systems.

### Embodiment 2

An operating method of the large-capacity bag-type constant-pressure accumulator as described in the Embodiment 1, which takes the energy recovery system of the hydraulic excavator boom as an example to demonstrate the application of the new large-capacity bag-type constant-pressure accumulator, as shown in FIG. 3.

The energy recovery system of the hydraulic excavator boom operates following the principle bellow: when the boom descends, the high pressure oil in the rodless chamber of the boom cylinder enters the accumulator for temporary storage to complete the process of energy recovery and storage; when necessary, the oil stored in the accumulator will be discharged to other loops at a constant pressure to complete the reuse of the recovered energy; such a process repeats in this way will achieve the purpose of energy conservation; the specific process is as follows:

When the boom descends, the rodless chamber of the boom cylinder 14 supplies oil to the accumulator to store energy: the variable area piston 4 will move under the driving of the high pressure oil, and then squeezes the bag 2; then, the pressure inside the bag 2 increases as the gas is compressed. During this process, the effective force-bearing area of the variable area piston 4 will decrease gradually.

When the boom rises, the gas in bag 2 of the accumulator will expand and deliver pressure via the piston to discharge hydraulic oil to the system and assist the system in work, thus reducing the load of the engine and the oil pump, which can not only saves energy but also prolongs the service life of the whole machine.

The floating piston chamber can store part of the oil in the energy storage process, which not only can increase the oil storage capacity, but also can reduce the repeated compression and expansion of the accumulator bag due to system pressure pulsation; in the energy release process, it can stabilize the pressure by further reducing the pressure pulsation of the oil discharged, thus better achieving constant-pressure output.

When the gas in the bag 2 expands, the gas pressure decreases gradually, while the effective force-bearing area of the variable area piston 4 increases. Therefore, by designing the variable area piston scientifically, the product of the two can be maintained the same to achieve constant-pressure output. The floating piston 5 acts as a seal and can avoid the direct contact of the bag 2 with the hydraulic oil in normal cases, thus extending the service life of the bag. Even if in extreme cases where the bag breaks up, the floating piston 5 can also isolate the gas the liquid relying on its sealing effects, preventing a large amount of gas from entering the hydraulic system and thus greatly improving the safety factor of the accumulator.

As shown in FIG. 5a, if the cup-shaped variable area piston is enlarged under the premise of maintaining the piston area and the bag inflation pressure unchanged, the oil can be discharged more fully, thus increasing the effective volume and reducing the “dead volume” to a large extent. However, the bag also needs to be enlarged as the variable area piston enlarges. Where the variable area piston has a large cross-sectional area, the upper part of the shell shall be larger than the lower part in diameter (namely a pear-shaped shell) in order to accommodate the deformation of the variable area piston and the bag. In this case, to prevent the occurrence of sealing failure when the piston moves up excessively, a limit device may be added.

What is claimed is:

1. A large-capacity bag-type constant-pressure accumulator, which comprises a shell and a bag placed in the shell, as well as a variable area piston, a floating piston, a piston, and a flange; on the piston rod of the variable area piston is mounted the floating piston, while at the bottom of the variable area piston rod is connected the piston; additionally, through holes are provided on the central axes of the variable area piston and the piston; such holes are connected to the bag through an inflation valve and connected with a cover plate at the bottom; on the piston are arranged a check valve I and a check valve II; the flange is connected to the inner wall of the shell bottom.

2. The large-capacity bag-type constant-pressure accumulator as described in claim 1, which is characterized in that the variable area piston is of an arc shaped construction.

3. The large-capacity bag-type constant-pressure accumulator as described in claim 1, which is characterized in that the piston rod of the said variable area piston is connected to the piston with threads with its bottom.

4. The large-capacity bag-type constant-pressure accumulator as described in claim 1, which is characterized in that on the surface of the piston are provided multiple grooves in which O-rings are placed.

5. The large-capacity bag-type constant-pressure accumulator as described in claim 1, which is characterized in that the said inflation valve is connected to the through holes with threads.

6. The large-capacity bag-type constant-pressure accumulator as described in claim 1, which is characterized in that the said cover plate is provided with a threaded stud which is inserted into the bottom of the through holes and connected to the holes with threads.

7. The large-capacity bag-type constant-pressure accumulator as described in claim 1, which is characterized in that a sponge gasket is provided between the cover plate and the piston; the cover plate is provided with a small hole.

8. The large-capacity bag-type constant-pressure accumulator as described in claim 1, which is characterized in that the said flange is connected to the inner wall of the shell through treads and fixed by set screws.

9. The large-capacity bag-type constant-pressure accumulator as described in claim 1, which is characterized in that the said piston is provided with two check valve Is and two check valve Is which are arranged and evenly distributed on the same circle at certain spacing, but opening direction is opposite to each other.

10. An operating method of the large-capacity bag-type constant-pressure accumulator as described in claim 1, which comprises steps as follows:
when the accumulator stores energy, high pressure will build up on the hydraulic oil side and drives the variable area piston to move; the variable area piston then squeezes the bag and the pressure inside the bag increases as the gas is compressed; during this process, the effective force-bearing area of the variable area piston will decrease gradually; then, the check valve I open and the check valve II close; and the oil flows through the check valves into the chamber of the floating piston, which can reduce the speed of the bag being compressed while increase the accumulator capacity, thus reducing heat production;
when the accumulator releases energy, the variable area piston will deliver pressure to push the hydraulic oil to discharge; with the expanding of the gas inside the bag, the pressure of the gas will gradually decrease, while the effective force-bearing area of the variable area piston will enlarge; then, the check valve I close, and the check valve II do not open until the oil pressure inside the chamber of the floating piston becomes larger than the set oil pressure in the chamber of the piston; after the check valve II open, the oil will be discharged into the chamber of the piston via the valves, which can reduce the pressure pulsation when the accumulator releases energy and maintain a constant pressure.
